(19) United States
(12) Patent Application Publication
(10) Pub. No.: US 2023/0203725 A1
(43) Pub. Date: Jun. 29, 2023

(54) Method for producing a fibrous web containing polylactide fibres

(71) Applicant: McAirlaid's Vliesstoffe GmbH, Berlingerode (DE)

(72) Inventor: Andreas SCHMIDT, Duderstadt (DE)

(73) Assignee: McAirlaid's Vliesstoffe GmbH, Berlingerode (DE)

(21) Appl. No.: 18/011,216

(22) PCT Filed: Jun. 18, 2021
(86) PCT No.: PCT/DE2021/100525

§ 371 Date: Dec. 19, 2022

(30) Foreign Application Priority Data
Jun. 22, 2020 (DE) 10 2020 116 399.1

(51) Int. Cl. D04H 1/55; D04H 1/732; D04H 1/551

(52) U.S. Cl. CPC D04H 1/55; D04H 1/732; D04H 1/551; D10B 2201/01; D10B 2401/062; D10B 2401/041

(57) ABSTRACT

A method for producing a fibrous web includes: (a) a fibrous ply containing polylactide fibers and, as necessary, other fibers are laid on a substrate in a random fiber arrangement, (b) initially a loose, pre-compressed nonwoven is created by applying a first pressure to the fibrous ply, the tear resistance of which nonwoven permits free bridging of a span between 0.1 m and 1 m before the nonwoven tears, (c) the pre-compressed nonwoven is then passed through the calender gap, wherein a pattern consisting of point or linear pressure zones is formed in the gap, with the fibers in the pressure zones being exposed to a second pressure, which is higher than the first pressure, and to a temperature such that the fibers fuse.

### TECHNICAL FIELD

The present disclosure relates to a method of producing a fibrous web containing polylactide fibers, to fibrous webs obtainable by the method claimed, and to the use of the fibrous webs produced.

### BACKGROUND

Products based on fibers in the form of web material, especially composed of fibers made of cellulose, of plastics, or of fiber mixtures, are known from the prior art. They find various uses as absorption materials for liquids, as in hygiene products, as filter materials and in packaging.

In all areas of life, great value is now placed on biodegradability of the materials used, especially in the case of consumable goods. WO 99/25281 discloses a method of producing a fibrous web consisting of cellulose fibers for use in hygiene articles. For production of the fibrous web, a fiber ply of cellulose fibers is first placed randomly onto a substrate, this fiber ply is precompacted under relatively low pressure, as a result of which a loose mat is obtained having low density and a tear strength that permits bridging between 0.1 m and 1 m before the mat tears, followed by introduction of the mat obtained into the nip of a calender roll pair with which a pattern of dotted or linear compression regions is generated, in which the fibers lying in a random arrangement are pressed together under a pressure in the range between 150 and 600 MPa. Fusion of the fibers is obtained, and a fibrous web with an embossed pattern is produced. The fibrous web produced contains virtually no binders, and so it can be considered to be completely biodegradable.

The webs of biodegradable fibers that are known from the prior art have good wet strength under customary stresses. Wet strength is sufficient for use in hygiene products, since hygiene products are typically not subjected to mechanical stresses. It is also possible to improve the wet strength of hygiene products by adding what are called superabsorbents, which simultaneously increase the absorptivity of the fibrous web with respect to liquids. This improvement only occurs when the fibrous web is brought into contact with aqueous liquids, such that the particles of superabsorbents swell up.

The bendability and flexibility of the webs is utilized in order to process them to three-dimensional filter bodies. Such filter bodies are described, for example, in international patent application WO 2010/112024 A2. The filter material is produced proceeding from a web material. The fiber web is crimped to form channels that extend in longitudinal direction of the air stream to be cleaned. Under dry conditions, the channels formed have a stable structure, but this can collapse at higher air humidity.

As well as the naturally occurring fibers that are all biodegradable, there are also known synthetic fibers that can be degraded by means of composting methods. The group of biodegradable polymers includes the polylactides (PLA). The polylactides are typically used in the form of what are called PLA blends, which are processed by means of extrusion, thermoforming, injection molding, and also blowmolding.

### SUMMARY

It was an object of the present disclosure to provide a fibrous web that has been produced from environmentally compatible components, preferably biodegradable fibers, and has good strength even in the wet state and under stress.

The present disclosure provides a method of producing a fibrous web comprising polylactide fibers and optionally further fibers, in which
a) a fiber ply comprising polylactide fibers and optionally further fibers in a random fiber arrangement is placed onto a substrate,
b) by exerting a first pressure on the fiber ply, first a loose precompacted mat is produced, the tear strength of which permits unsupported bridging of a span between 0.1 m and 1 m before the mat tears,
c) the precompacted mat is subsequently run through the nip of a calender, wherein a pattern of dotted or linear compression regions is produced in the nip, wherein the fibers in the compression regions are subjected to a second pressure higher than the first pressure, and such a temperature that fusion of the fibers occurs.

The method makes it possible to produce biodegradable fibrous webs containing polylactide fibers and optionally further fibers that have good wet strength even in a mixture with other fibers, for example cellulose fibers. For instance, fibrous webs including a predominant proportion of cellulose fibers as well as the polylactide fibers have distinctly improved wet strength compared to fibrous webs consisting exclusively of cellulose fibers.

It is also possible to process fibrous webs that have been produced predominantly from polylactide fibers in a further production step to give three-dimensional shaped bodies that feature dimensional stability.

The inventors assume that the fusion of the fibers in the compression regions is effected firstly by melting of the polylactide fibers, in which case the polylactide fibers can melt together and can also enter into a bond to any other fibers present. It is also possible that the fibers, under the method conditions, i.e. under the pressure and temperature conditions, can enter into a bond with one another, in which case the type of bond established is not known to the inventors, nor whether it is a physical and/or chemical bond.

The processing of polylactide fibers according to the present invention utilizes the component steps of an airlaid method by which cellulose fibers are processed in the prior art. The use of polylactide fibers in an airlaid method enables the production of biodegradable products having low weight per unit volume and a broad spectrum of properties. Webs produced predominantly to an extent of 100% from polylactide fibers can form dimensionally stable fibrous webs and then be processed to three-dimensional shaped bodies having very low weight and good biodegradability.

Moreover, fibrous webs containing cellulose fibers and a relatively low proportion of polylactide fibers are flexible and bendable and have good absorption capacity with respect to liquids and gases.

The properties of the material web of the disclosure are determined not just by the ratio of polylactide fibers to cellulose fibers, but also by the amount of fibers used overall, i.e. by the thickness of the laid fiber ply, which is produced in method step a).

The polylactide fibers used in accordance with the disclosure are synthetic fibers. Polylactides are among the polyesters; they exhibit thermoplastic properties in that they melt and can be subjected to shaping methods at melting temperature. The melting point of the polylactides is typically between 150° C. and 160° C.

In the method, preference is given to using polylactide fibers having a fiber length of 3 to 10 mm. the fibers should have sufficient fineness, a preferred fineness being between 0.7 and 3.0 dtex and especially between 1.0 and 1.5 dtex.

In a preferred embodiment, the polylactide fibers are used in a mixture with cellulose fibers. Cellulose fibers used are preferably those fibers known as “fluff pulp” in the prior art. Fluff pulp is a standardized product made from wood which is produced from a cellulose material supplied in the form of boards, flash-dried bales or sheets, called “wood pulp cardboards”, by comminuting it and separating it into fibers before use, typically in hammer mills, until a cotton wool-like product composed of cellulose fibers, namely “fluff pulp”, has formed.

In a first method step a), the fibers, i.e. the polylactide fibers and optionally further fibers, such as cellulose fibers, in a random fiber arrangement are placed onto a substrate. The fibers are typically transported in an air stream and deposited on a substrate. This procedure is also called the airlaid method.

If a mixture of cellulose fibers and polylactide fibers is used, the cellulose fibers, as described above, are preferably separated into fibers in a hammer mill and transported in an air stream into a mixer. In a separate air stream, the polylactide fibers are supplied to the mixer. By mixing the two air streams, the individual fibers are also mixed. A random fiber arrangement is obtained. The laid fiber ply typically has a bed height of about 5 to 15 mm.

The amount of fibers deposited on the substrate determines the bed height of the laid fiber ply and ultimately also the basis weight of the finished fibrous web.

In a further method step b), the laid fiber ply obtained in method step a) is processed further by exerting a first pressure on the fiber ply in order to form a loose precompacted mat, the tear strength of which permits the unsupported bridging of a span between 0.1 m and 1 m before the mat tears. In method step b), the laid fiber ply is guided, preferably on a conveyor belt or a moving screen, through a first precompaction station, which may, for example, be a calender roll pair at a first pressure, so as to give rise to a loose mat having low density and tear strength. The tear strength should be such that the mat in this processing state would be able to hang unsupported over a length of about 0.1 to 1 m without tearing. As a result, the mat should also be able to withstand an air pressure as can occur in a production method.

In method step c), the mat obtained in method step b) is run through the nip of a calender roll pair, wherein a pattern of dotted or linear compression regions works against the material web in the nip. Particularly in the compression regions, the fibers are subjected to such a second pressure that fusion of the fibers occurs. The pressure in the discrete compression regions is typically at least 100 MPa and is preferably between 150 and 600 MPa. The high pressure in the discrete compression regions is achieved by using calender rolls with pimples, mutually interlaced line patterns or other protruding dotted or linear compression surfaces. The pattern density of these compression regions is preferably between 1 and 16 pattern dots per cm2. A more detailed description of this method step can be found in WO 99/25281, to which specific reference is made here.

By the above-described method, a fibrous web preferably having a basis weight between 50 g/m2 and 1500 g/m2 is obtained.

The fibers in a random arrangement are pushed against one another under very high local pressure in the compression regions that are dotted or linear, for example. In the compression regions, the temperature and pressure are adjusted such that the polylactide fibers of the fiber web melt and are inextricably bonded to one another at these pressure points. The temperature of the compression regions is preferably between 100° C. and 200° C. This intimate bonding may also be referred to as cohesive bonding similarly to a weld bond.

If any cellulose fibers present are not bonded to one another via partly molten polylactide fibers, it is assumed that they are thermomechanically bonded to one another, the nature of this bond being unknown.

If a mixture of polylactide fibers with other fibers is used, for example cellulose fibers that do not melt at the method temperatures and pressures, these other fibers are enclosed by molten polylactide, and an intimate bond is formed between the individual fibers. In these regions, the individual fibers cannot be detached again from one another; these regions can be divided only by cutting or tearing. The bonding of the fibers brings about an increase in strength in the compression regions, with the consequence of an improvement not only in tear strength in general, but especially in the stability to air humidity and wet strength of the resultant fibrous webs, compared to fibrous webs containing cellulose only.

In one possible embodiment, this fibrous web, on at least one of its surfaces, has a web of textile, fleece-like, paper- or film-like material to which the web is adhesive bonded and/or welded and/or mechanically bonded.

In a particularly preferred embodiment, in the production of the fibrous web in method step a), the laid fiber ply is applied to a web. If the fibrous web is to have a web of textile, fleece-like, paper- or film-like material on both surfaces, it is possible in one possible embodiment to apply the second web after method step a). The three plies of fiber material as core and web material on the respective lower or upper surface may be precompacted together in method step b) and then processed further together in method step c).

In one possible embodiment, the strength of the fiber web can be increased further by subjecting the web to thermal energy in a downstream method step d). In the thermal aftertreatment step, even those polylactide fibers outside the compression regions are (partly) melted and are bonded at least partly to one another and/or to any other fibers present. The aftertreatment with thermal energy can be effected, for example, with hot gas, by means of hot calendering rolls between which the fiber web is inserted, or using electromagnetic waves.

In a preferred embodiment, the thermal aftertreatment is effected with electromagnetic waves having a wavelength of 30 cm to 1 mm. Electromagnetic waves having said wavelength of 30 cm to 1 mm are called microwaves. Polylactides are active toward microwaves, i.e. the fibers are (partly) melted, depending on the energy supplied, such that fusion of further fibers within the fibrous web is effected and the strength of the fibrous web can be increased further. In the case of treatment with microwaves, there is also (partial) melting of fibers outside the compression regions of method step c). The irradiating of the fibrous web with microwaves can be effected, for example, by directly irradiating the fibrous web obtained from method step c) with microwaves in a method step d). This treatment of the fibrous web or of blanks and products produced therefrom can be effected in a manner known per se by means of customary microwave equipment.

For performance of method step d), the fibrous web or a blank thereof can first be processed to the shape of the desired end product, and only then irradiated with the microwaves. At least a portion of the polylactide fibers melts and, after cooling, retains the desired shape in a dimensionally stable manner, such that the end product thus produced is also dimensionally stable, for example a dish.

The present disclosure further provides a fibrous web which is obtainable by the method described above and has the feature that it contains a mixture of polylactide fibers and cellulose fibers. It is possible to produce fibrous webs having a proportion of polylactide fibers of up to 100%, the properties of which can be adjusted depending on the proportions of the polylactide fibers and other fibers, such as cellulose fibers. Fibrous webs consisting predominantly of cellulose fibers show high absorptivity, and fibrous webs having a relatively high or high proportion of polylactide fibers or even 100% polylactide fibers can be converted by customary shaping methods to a three-dimensional shape, for example, which they retain.

The present disclosure still further provides a fibrous web containing 5% by weight to 100% by weight of polylactide fibers and 0% by weight to 95% by weight of cellulose fibers, and wherein the polylactide fibers and cellulose fibers are fused in an embossed pattern of dotted or linear embossment regions. In a preferred embodiment, the fibrous web contains 10% by weight to 100% by weight of polylactide fibers and 0% by weight to 90% by weight of cellulose fibers.

One possible embodiment relates to a fibrous web comprising 5% by weight to 30% by weight of polylactide fibers and 70% by weight to 95% by weight of cellulose fibers, especially 8% by weight to 20% by weight of polylactide fibers and 80% by weight to 92% by weight of cellulose fibers, and optionally further fibers, wherein the polylactide fibers and cellulose fibers are fused in an embossed pattern of dotted or linear embossment regions.

The present disclosure accordingly further provides a fibrous web which is obtainable by the method described above and is characterized in that the fibrous web contains 17% by weight to 40% by weight of polylactide fibers and 60% by weight to 83% by weight of cellulose fibers and the polylactide fibers and cellulose fibers are fused in an embossed pattern of dotted or linear embossment regions. In this configuration, the fibrous webs show good wet strength.

Fibrous webs of the disclosure that have a predominant proportion of cellulose fibers are notable for high absorption capacity combined with wet strength, i.e. high strength in the wet state. The fibrous web is especially suitable as absorption material in hygiene products, food packaging, as filter material for filtering of liquids and gases, or as packaging material for sensitive articles.

When the proportions of polylactide fibers are too low, it is possible to impart a higher strength to the fibrous web compared to fibrous webs consisting solely of cellulose fibers. Even in the case of proportions of polylactide fibers of 10% by weight or higher, it is possible to convert the fibrous webs to a three-dimensional shape by means of shaping methods known from the prior art.

A suitable shaping method is especially the thermoforming method. For this purpose, individual blanks of the fibrous web are subjected to thermoforming, for example by means of reduced pressure, and optionally, as described above, then subjected to a thermal aftertreatment in order to stabilize the shape obtained.

The present disclosure further relates to a method of producing three-dimensional shaped bodies in which the fibrous web is processed by shaping methods known from the prior art to give shaped bodies, such as dishes, pipes, filter bodies, etc.

In one possible embodiment, the fibrous web is heated to a temperature above the melting point or softening point of the polylactide fibers and shaped to a shaped body in a shaping step to form a depression. What is unusual here is that the fibrous web, for stabilization of the shape, is first heated above the melting point of the polylactide fibers by means of a heated shaped body or microwave. This achieves liquefaction and hence enclosure of the cellulose fibers with polylactide. The shaped body is finally cooled down below the melting point of the polylactide.

The fibrous webs and shaped bodies produced therefrom are notable for a low density and good biodegradability. If the shaped body composed of the fibrous web is used, for example, as dish-shaped food packaging, this packaging may also be composted like the food residues.

A further embodiment relates to a filter material that can be obtained from a fibrous web produced by the above-described method. In one possible embodiment, the filtering operation is effected by passing the material, air, gas or liquid, to be filtered, through the fibrous web and effecting the filtering operation through the fiber structure.

A fibrous web which is to be used for cleaning of air and gases is preferably laid to form channels that extend in longitudinal direction of the gas or air stream to be cleaned. The air or gases are cleaned along these channels. In a preferred embodiment, the fibrous web and optionally further layers present are first crimped and then laid to form channels that extend in longitudinal direction of the air stream to be cleaned. The body thus produced is preferably a rod-shaped body.

Further consolidation of the filter material can be achieved in an aftertreatment step by subjecting the optionally crimped and already laid material to a treatment with microwaves. In the case of microwave treatment, it should be ensured that it does not take too long, since it is necessary to prevent all the polylactide fibers present in the fibrous web from undergoing partial melting and the loose composite from being destroyed. It is suspected that this consolidation of the filter material is achieved in that the polylactide fibers outside the embossment points are likewise melted to a certain degree.

In one possible embodiment of the method, a tubular body is produced for various possible applications. For this purpose, one or more blanks of the fibrous web produced in accordance with the disclosure are first used to form an elongated, preferably rod-shaped body. This may be of round, rectangular or a different cross section. This body is then, as known similarly from the production of seamless steel pipes, run around a stable mandrel in longitudinal direction, as a result of which the body is deformed, and a longitudinal channel is formed within the body. By the same shaping method in principle, it is also possible, for example, to introduce longitudinal grooves into the rod-shaped body.

Subsequently, the tubular body, for sustained assurance of its shape, may be heated, and possibly also compressed and/or irradiated with electromagnetic waves, for example by means of one of the process alternatives already described above. After cooling, the resultant tube, if it is of high length or has even been produced continuously, may also be cut to the length desired for the respective end use.

### BRIEF DESCRIPTION OF THE DRAWINGS

The invention is illustrated and explained in detail with reference to the following figures.

FIG. 1 shows an enlarged diagram of a fiber web in cross section through the compression region of two calender rolls with pyramid-shaped pimples;

FIG. 2 shows a section through the fiber material in the crimped state;

FIG. 3 shows a perspective view of a body in tubular configuration, produced from the fiber material according to FIG. 1, with partial omission of a sheath layer;

FIG. 4 shows a cross section in the A/A plane in FIG. 3;

FIG. 5 shows a schematic overview diagram of the method.

### DETAILED DESCRIPTION

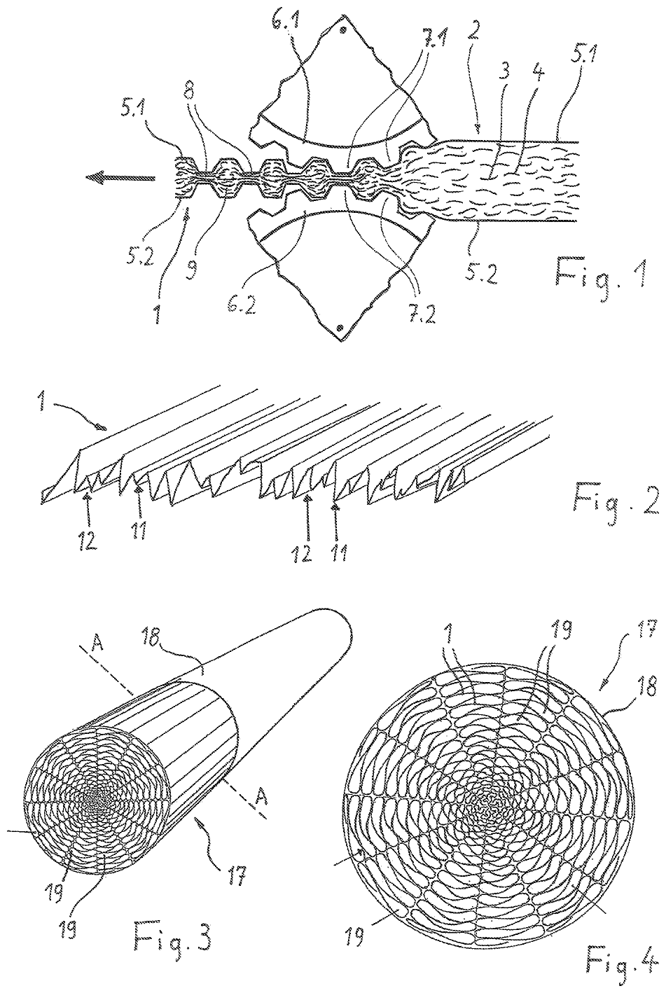

FIG. 1 shows a cross section of a step in the formation of a fiber web 1 containing polylactide fibers 3 and cellulose fibers 4. FIG. 1 shows, on the right-hand side, a loose, only precompacted mat 2 containing both fibers 3 of polylactide (polylactide fibers) and cellulose fibers 4. The fibers 3 and 4 shown are shown merely by way of example and do not reflect the amount, thickness and length of the fibers actually present.

On the top side and/or on the bottom side of the fiber web 1, it is additionally possible to apply a thin web material 5.1, 5.2, for example webs of textile, fleece-like or film-like material.

The precompacted mat is run through the nip of a calender roll pair 6.1, 6.2 which is shown in each case only in segments in FIG. 1. The surfaces of the calender rolls have projections 7.1 and 7.2, such that, in the regions in which these projections 7.1 and 7.2 meet, discrete, e.g. dotted, pressure regions are formed, in which a considerable pressure is applied to the mat. In these regions, the fibers are compressed, forming discrete embossment regions 8. The pressure in these embossment regions should be at least 100 MPa; in the present embodiment, the pressure is about 520 MPa. The rolls or projections on the rolls may be configured correspondingly for generation of such a pressure. For example, it is possible to use rolls with pimples, mutually interlaced line patterns or other protruding dotted or linear compression surfaces 7.1, 7.2. The pattern density of these dotted compression regions is preferably between 1 and 16 pattern dots per cm².

The rolls of the calender roll pair 6.1, 6.2 are heated, for example by means of electrical heating elements, such that the temperature at least in the compression regions 7.1, 7.2, in addition to the pressure, is such that the polylactide fibers are partly or fully melted, so as to result in a cohesive bond between the individual polylactide fibers and optionally also with inclusion of the cellulose fibers.

The (partial) melting of the polylactide fibers allow the cellulose fibers also to be completely enclosed by polylactide melt. In these regions, also called embossment regions, fusion of the fibers occurs, such that these fibers cannot be separated from one another without difficulty, especially not without destroying the embossment region 8.

After exiting from the calender 6.1, 6.2, a fibrous web 1 is obtained, in which the fibers in the regions 9 form a loose composite. The elevated stability and strength of the fiber web 1 is attributable to the cohesive bonding of the polylactide fibers in the embossment regions 8.

In a further step, the fibrous web 1, for example, is processed further to give a filter material for cleaning of air and gases. For this purpose, the fibrous web is preferably first crimped, as shown in FIG. 2. The individual layers are not shown here. In the configuration shown here, the fiber web material is laid in irregular folds. A filter material is obtained, which, in addition to the existing embossment regions 8, has a crimped surface structure with alternating elevations 11 and depressions 12. This achieves an increase in surface area which is advantageous for the filter process.

FIG. 3 shows a rod-shaped filter 17, formed from the fiber web material 1 in the form of a sheet-like structure as shown in FIG. 1 and from a surrounding sheath layer 18 that has been partly omitted in FIG. 3. The web material 1 in the embodiment shown here is alternately laid or folded, forming channels 19 that extend in longitudinal direction of the filter. The alternate laying may be uniform or nonuniform. The gas to be cleaned can pass through the channels 19 and through the fiber layer 1 of the filter material. The gas to be cleaned thus preferably flows along the folded layers, i.e. along the surfaces of the fibrous material, and not transverse thereto, and if it does so, only to a small extent through the layers 1. The pressure drops are therefore only low.

The strength of the embossment regions 8 and the stability thereof to moisture has the effect that the channels 19 do not collapse but retain their shape even under relatively high air humidity and at a relatively high moisture content of the gases to be filtered or cleaned.

In the embodiment shown here, the filter is surrounded by a sheath layer 18. In the case of use of the filter 17 as cigarette filter, the sheath layer 18 may be a simple wrapping paper that may surround both the tobacco rod of the cigarette (not shown here) and the cigarette filter in one-piece form. It is also possible that the sheath layer 18 surrounds the filter 17 only.

The surface of the fiber web 1 forms the inner surface of the channels 19. The embossment regions 8 and the crimping of the material result in formation of an uneven surface structure of the channel walls, which has a positive effect on the filtering action of the filter.

FIG. 4 shows a section through the filter along the line A-A in FIG. 3. The filter material 1, as shown here, is laid alternately, such that the channels 19 form in longitudinal direction of the rod-shaped filter. The alternately laid filter material may be in a symmetric or unsymmetric arrangement within the filter 17. In the embodiment shown here, the alternately laid filter materials form individual circle segments. The arrangement of the plies of filter material may also be irregular.

The filter material can also be used in systems for cleaning of air and gases. The web material 1, as shown in FIGS. 3 and 4, may be laid in the form of a cylinder; the shape of the filter used in the systems may otherwise be as desired, for example box- shaped or in any other conceivable shapes.

In a further method step, the strength of the fibrous web 1 may be increased by subjecting the fibrous web 1 to a thermal treatment. The inventors assume that even the polylactide fibers present in the uncompressed regions 9 (FIG. 1) are (partly) melted and become bonded to one another or enter into a bond with any other fibers present, such as cellulose fibers. The thermal treatment can be effected by methods known to the person skilled in the art, such as by means of hot gas or microwaves, or else by running the fibrous web through hot calender rolls.

In a further processing step, it is possible to produce a three-dimensional shaped body from the material of the above-described fibrous web 1. For this purpose, the fibrous web 1, after passing through method step c), i.e. when it leaves the nip of the calender roll pair 6.1, 6.2, is subjected to a shaping method, for example a thermoforming method. For this purpose, the fibrous web or a blank obtained therefrom is converted to the desired shape by means of reduced pressure or other methods and then subjected to a thermal aftertreatment as already described above. During the thermal aftertreatment, the polylactide fibers are (partly) melted to such an extent that the fibrous web 1 adapts to the shape. After cooling, the shape thus formed remains dimensionally stable, and a permanent three-dimensional body is obtained. The individual shapes thus produced are separated from one another even during the shaping process or during or after the thermal aftertreatment and sent to further use.

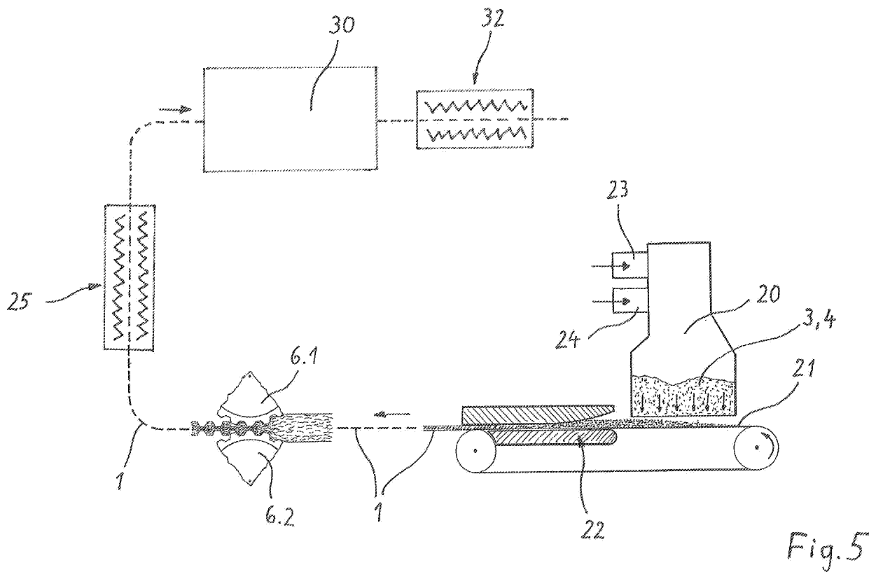

FIG. 5 shows the method scheme for production of the fibrous web 1 and further processing thereof.

Fibers of polylactide 3 via a feed 23, and further fibers, for example cellulose fibers 4, via a separate feed 24 enter a mixing space 20 in which the different fibers are mixed, before they arrive at a substrate, here a revolving conveyor belt 21, as a mixture in an air stream, and form a fiber layer on the conveyor belt 21. The conveyor belt 21 may, for example, be an air-permeable screen belt. The fiber layer thus positioned is then guided together with the revolving belt 21 through a lightly compressing calender 22 or compaction gap. This exerts a first pressure on the fiber ply, so as to form a compacted mat 2.

The mat 2 thus precompacted is then run through the nip of the calender roll pair 6.1, 6.2 according to FIG. 1. This calender roll pair 6.1, 6.2 has the pattern of projections 7.1, 7.2. These projections constitute the compression regions, which generate a higher pressure than in the calender, and result in a pattern of dotted or linear compression regions. The second, higher pressure in combination with the application of heat to the mat has the effect that fusion of the fibers occurs.

After exiting from the calender roll pair 6.1, 6.2, the fibrous web 1 thus obtained is sent to further processing. In the embodiment shown here, the fibrous 1 is first sent to a further, independent thermal treatment 25, for which purpose it is subjected, for example, to electromagnetic rays, for example a treatment with microwaves.

The intermediate product that has thus undergone thermal aftertreatment can be processed further to corresponding blanks and/or processed in a subsequent shaping process 30 to give a three-dimensional product. For example, the blanks may be processed further in the shaping process 30 by thermoforming to give a three-dimensionally configured end product, for example to give a dish or a rod-shaped body. The shaping process 30 may be followed by a further thermal treatment 32 by which sustained consolidation of the product is achieved.

### LIST OF REFERENCE NUMERALS

1 fibrous web

2 mat from method step b)

3 fibers of polylactide

4 cellulose fibers

5.1, 5.2 web material

6.1, 6.2 calender roll pair

7.1, 7.2 projections

8 embossment regions

9 uncompressed regions

10 shape

11 elevations

12 depressions

17 filter

18 sheath layer

19 channels

20 mixing space

21 conveyor belt

22 calender

23 feed

24 feed

25 thermal treatment

30 shaping process

32 thermal treatment

1.-18. (canceled)

19. A method of producing a fibrous web comprising polylactide fibers, comprising:
(a) placing a fiber ply comprising polylactide fibers and optionally further fibers in a random fiber arrangement onto a substrate;
(b) exerting a first pressure on the fiber ply, thereby producing a loose precompacted mat, a tear strength of which permits unsupported bridging a span before the mat tears; and
(c) subsequently running the precompacted mat through a nip of a calender,
wherein a pattern of dotted or linear compression regions is produced in the nip, and
wherein the fibers in the compression regions are subjected to a second pressure higher than the first pressure, in conjunction with such a temperature that fusion of the polylactide fibers occurs.

20. The method as claimed in claim 19,
wherein the fiber ply contains a mixture of the polylactide fibers and cellulose fibers.

21. The method as claimed in claim 19,
wherein the polylactide fibers have a fiber length of 3 to 10 mm.

22. The method as claimed in claim 19,
wherein the polylactide fibers have a fineness between 0.7 and 3.0 dtex.

23. The method as claimed in claim 19,
wherein the polylactide fibers have a fineness between 1.0 to 1.5 dtex.

24. The method as claimed in claim 19,
wherein, in method step c), the second pressure and the temperature are adjusted such that a melting range of the polylactide fibers is attained.

25. The method as claimed in claim 19, further comprising
subjecting the fibrous web to electromagnetic waves with a wavelength of 300 mm to 1 mm.

26. The method as claimed in claim 19, further comprising
subjecting the fibrous web to a hot gas stream.

27. The method as claimed in claim 19, further comprising
subjecting the fibrous web to a hot calendering method.

28. A fibrous web, comprising:
5% by weight to 30% by weight of polylactide fibers; and
70% by weight to 95% by weight of cellulose fibers,
wherein the polylactide fibers and the cellulose fibers are fused in an embossed pattern of dotted or linear embossment regions.

29. A hygiene product, a food packaging, or a filter materials for filtering of liquids and gases, comprising the fibrous web as claimed in claim 28 as an absorption material.

30. The fibrous web as claimed in claim 28,
further comprising, on at least one of its surfaces, a web of textile, fleece-like or film-like material to which the fibrous web is adhesive bonded and/or welded and/or mechanically bonded.

31. A hygiene product, a food packaging, or a filter materials for filtering of liquids and gases, comprising the fibrous web as claimed in claim 30 as a carrier material for auxiliaries.

32. A fibrous web, comprising:
17% by weight to 40% by weight of polylactide fibers; and
60% by weight to 83% by weight of cellulose fibers,
wherein the polylactide fibers and cellulose fibers are fused in an embossed pattern of dotted or linear embossment regions.

33. A hygiene product, a food packaging, or a filter materials for filtering of liquids and gases, comprising the fibrous web as claimed in claim 32 as an absorption material.

34. The fibrous web as claimed in claim 32,
further comprising, on at least one of its surfaces, a web of textile, fleece-like or film-like material to which the fibrous web is adhesive bonded and/or welded and/or mechanically bonded.

35. A hygiene product, a food packaging, or a filter materials for filtering of liquids and gases, comprising the fibrous web as claimed in claim 34 as a carrier material for auxiliaries.

36. The fibrous web produced by the method as claimed in claim 19,
wherein the fibrous web contains
10% by weight to 100% by weight of polylactide fibers and
0% by weight to 90% by weight of cellulose fibers, and
wherein the polylactide fibers and cellulose fibers are fused in an embossed pattern of dotted or linear embossment regions.

37. The fibrous web as claimed in claim 35,
wherein the fibrous web is dimensionally stable and can be converted to a three- dimensional form by a shaping method.

38. The fibrous web as claimed in claim 37,
wherein the shaping method is a thermoforming method.

39. The fibrous web as claimed in claim 37,
wherein the shaping method is a pipe production method.

40. A three-dimensional shaped bodies comprising the fibrous web as claimed in claim 35.
